(19) United States
(12) Patent Application Publication
(10) Pub. No.: US 2015/0309552 A1
(43) Pub. Date: Oct. 29, 2015

(54) ENHANCEMENT IN LINUX ONDEMAND GOVERNOR FOR PERIODIC LOADS

(71) Applicant: Qualcomm Innovation Center, Inc., San Diego, CA (US)

(72) Inventors: Krishna V.S.S.S.R. Vanka, Hyderabad (IN); Sravan Kumar Ambapuram, Hyderabad (IN); Shirish Kumar Agarwal, Hyderabad (IN); Siddharth Gaur, Indore (IN)

(73) Assignee: Qualcomm Innovation Center, Inc., San Diego, CA (US)

(21) Appl. No.: 14/262,452

(22) Filed: Apr. 25, 2014

(51) Int. Cl. G06F 1/32

(52) U.S. Cl. CPC G06F 1/324

(57) ABSTRACT

An enhanced OnDemand Governor is disclosed that computes a steady-state frequency based on prior recommended CPU frequencies and applies a steady-state frequency when available. When not available, a turbo frequency or a computed lower frequency is applied. For increased loads, the steady-state frequency can be applied for one or more cycles until it becomes apparent that gradual frequency increases are not sufficient to meet a large CPU load, at which point the turbo frequency is applied and the history of CPU frequencies can be flushed. The enhanced OnDemand Governor can be turned on where periodic loads are detected while the traditional OnDemand Governor can be used in all other use cases.

### BACKGROUND

1. Field

The present disclosed embodiments relate generally to CPU frequency control, and more specifically to enhancement of the LINUX OnDemand Governor.

2. Background

While numerous governors are available for controlling CPU or processor frequency (e.g., OnDemand, Interactive, Conservative, Powersave, etc.), the OnDemand Governor is considered by many to perform the best tradeoff between power consumption and performance. The OnDemand Governor takes an approach of maximizing CPU frequency when CPU loads rise, thus ensuring that users do not see performance lags, and steps down the CPU frequency as loads slacken, thus weighing somewhat in favor of performance over power savings. While this works in many instances, and is best suited for dynamic loads, in cases where loads are more periodic, such as multimedia playback (e.g., rendering an online video) or gaming, the OnDemand Governor proves inefficient.

FIG. 1 illustrates a method of operating the OnDemand Governor as is well known to those of skill in the art. This method 100 performs once per sampling cycle (e.g., 50 ms) or once per expiration of a sampling timer. During each loop, the method 100 calculates a load on the CPU (Block 102) and then compares the CPU load to an upper and lower threshold, referred to as Up_Threshold and Down_Threshold. If the CPU load is greater than the Up_Threshold (Decision 104), then the method 100 instructs the CPU to operate at a turbo frequency (Block 106), or a highest available CPU frequency. The method 100 then returns to the beginning and waits for an expiration of the sampling timer. If the CPU load is less than the Up_Threshold but greater than the Down_Threshold, (Decisions 104 and 108), then the method 100 instructs the CPU to operate at a current frequency (e.g., a frequency set during the last loop of the method 100) (Block 112). Again, the method 100 then loops back to the beginning. If the CPU load is less than the Down_Threshold (decision 108), then the method 100 identifies a lower frequency sufficient to handle the CPU load and instructs the CPU to operate at this computed lower frequency (Block 110), and then again returns to the beginning. In particular, the OnDemand Governor takes the CPU load, as determined in Block 102, and compares this to a frequency table containing available CPU frequencies. If there is a match, then this frequency is used as the computed lower frequency. If an exact match does not exist, then a next highest CPU frequency in the table is used. In this way a lowest available frequency that can handle the CPU load is used.

One can see that typical operation of the OnDemand Governor leads to rapid CPU frequency spikes anytime the load rises, but the CPU frequency only gradually returns to a lower power consumption state, and can easily be swept back into a highly power consuming state if any load spike occurs during that gradual step down to lower power. Consequently, the CPU can spend considerable time at high CPU frequencies, and thus drain power faster than needed.

FIG. 2 illustrates the problem in the context of a periodic load such as playback of multimedia. The majority of multimedia playback scenarios involve periodic loads on the CPU, but are intermixed with intermittent processes. While the OnDemand Governor might be well-suited for multimedia on its own, the intermittent process runs cause the CPU to spend a large percentage of time. FIG. 2 shows a scenario where a CPU has six frequency levels: 250 MHz, 500 MHz, 750 MHz, 1000 MHz, 1250 MHz, and 1500 MHz. Much of the time is spent at the 750 MHz frequency. However, when an intermittent process run puts a slightly greater load on the CPU, an Up_Threshold can be breached and the OnDemand Governor can take the CPU frequency to the turbo frequency, as seen five times in the two second duration of the chart. It can then take many milliseconds for the CPU to step down to a frequency in line with the multimedia playback (e.g., 750 MHz). In one or more of these five jumps to the turbo frequency, the slightly increased load of one or more intermittent processors may not have required the full turbo frequency, and thus the OnDemand Governor causes unnecessary power consumption.

This example and the above description shows that the jump to the turbo frequency as well as the incremented step down therefrom, are performed without much regard for specific CPU load requirements. There is thus a need in the art for a CPU frequency governor that can more accurately tailor CPU frequency to load requirements while maintaining the performance benefits of the OnDemand Governor.

### SUMMARY

Embodiments disclosed herein address the above stated needs by computing a steady-state frequency (SSF) that can be applied along with the turbo frequency (given an increased CPU load) and a computed lower frequency (given a decreased CPU load). In particular, the governor (e.g., OnDemand Governor) can be modified to maintain a history of recent CPU frequency set points and use this history (e.g., via a filter) to calculate a steady-state frequency. Once sufficient confidence is built in the steady-state frequency (e.g., a sufficient number of values exist in the history, such as M), the governor can instruct the CPU to set its frequency based on the steady-state frequency in place of the turbo frequency (for increased loads) or a computed lower frequency (for decreased loads). For increased loads, the steady-state frequency can be applied for one or two cycles, and if it is still not sufficient to meet a rapidly increasing load, then it may be apparent that the steady-state frequency is not sufficient to meet such a load, and the turbo frequency can be applied. At the same time, when such one or two cycles of increased steady-state frequency prove inadequate to meet the increased load, the history can be flushed so that the steady-state frequency can start being built based on more recent CPU frequency values.

One aspect of the disclosure can be described as a system comprising a CPU, a history data store, and a CPU frequency governor. The CPU can operate at two or more available frequencies, and the history data store can be configured to store the two or more available frequencies. The CPU frequency governor can comprise a non-transitory, tangible computer readable storage medium, encoded with processor readable instructions to perform a method for controlling a frequency of the CPU. The method can comprise monitoring a load on the CPU, determining that the CPU load exceeds an upper threshold, adding a turbo frequency to the history data store, calculating a steady-state frequency based on a filtered set of frequencies in the history data store, and instructing the CPU to set its frequency to the steady-state frequency.

Another aspect of the disclosure can be described as a method of operating a CPU frequency governor in order to optimize performance and power savings for periodic CPU loads. The method comprises calculating a load on a CPU by integrating instantaneous loads on the CPU over a load sampling period. If the load the load is greater than an upper threshold, then the method can check if there have been N prior consecutive determinations that the load was greater than the upper threshold. If so, then the method can flush a history data store and instruct the CPU to set its frequency to a turbo frequency. If there have been less than N prior consecutive determinations that the load was greater than the upper threshold, then the method can add the turbo frequency to the history data store, compute a steady-state frequency from the history data store, and if the steady-state frequency is calculated from M or more data points in the history data store (or there are more than M data points in the history data store), then the method can set the CPU frequency to the steady-state frequency. If the steady-state frequency has not been calculated from M or more data points in the history data store (or there are less than M data points in the history data store), then the method can set the CPU frequency to the turbo frequency. If the load is between the upper threshold and the lower threshold, then the method can add a current CPU frequency to the history data store, compute the steady-state frequency from the history data store, and set the CPU frequency to the steady-state frequency. If the load is less than the lower threshold, then the method can add a computed lower frequency to the history data store, compute the steady-state frequency based on the history data store, and determine if the steady-state frequency is ready. If so, then the method can set the CPU frequency to the steady-state frequency, and if not, then the method can set the CPU frequency to the computed lower frequency.

Yet another aspect of the disclosure can be described as a non-transitory, tangible computer readable storage medium, encoded with processor readable instructions to perform a method for controlling a CPU frequency governor. The method can comprise monitoring a CPU load, determining that the CPU load exceeds an upper threshold, determining that N prior consecutive increases to the CPU frequency have been attempted, and instructing the CPU to set its frequency to a turbo frequency.

### BRIEF DESCRIPTION OF THE DRAWINGS

FIG. 1 is a method of operating a traditional OnDemand Governor;

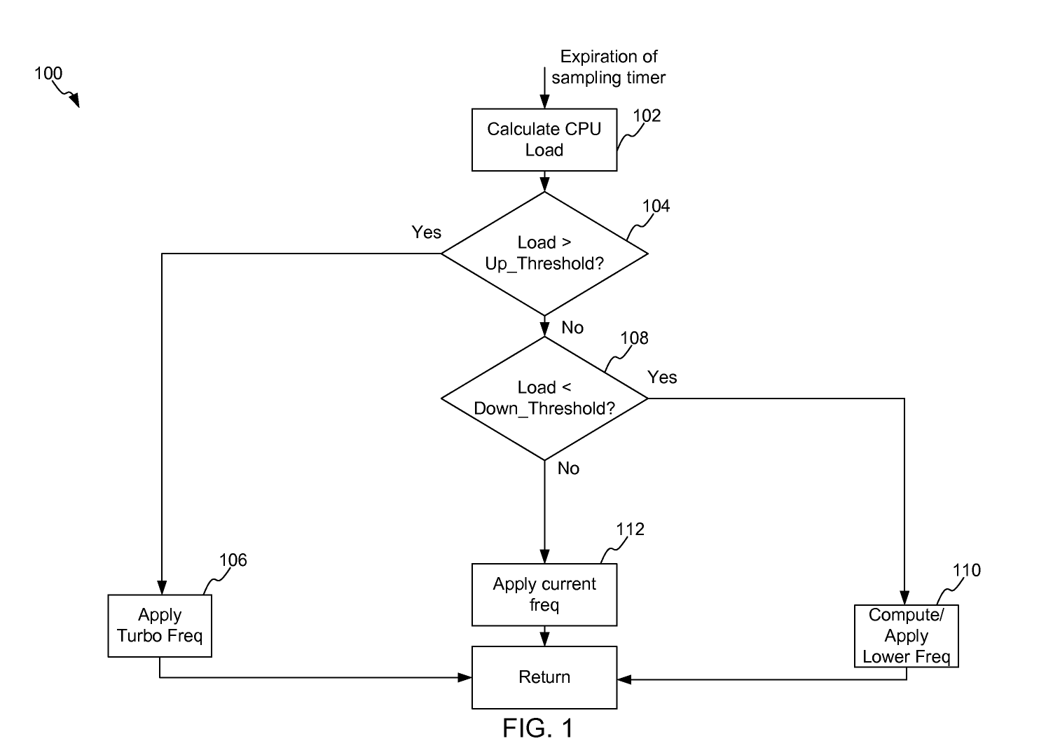

FIG. 2 is a CPU frequency versus time chart showing CPU frequency recommendations of a traditional OnDemand Governor;

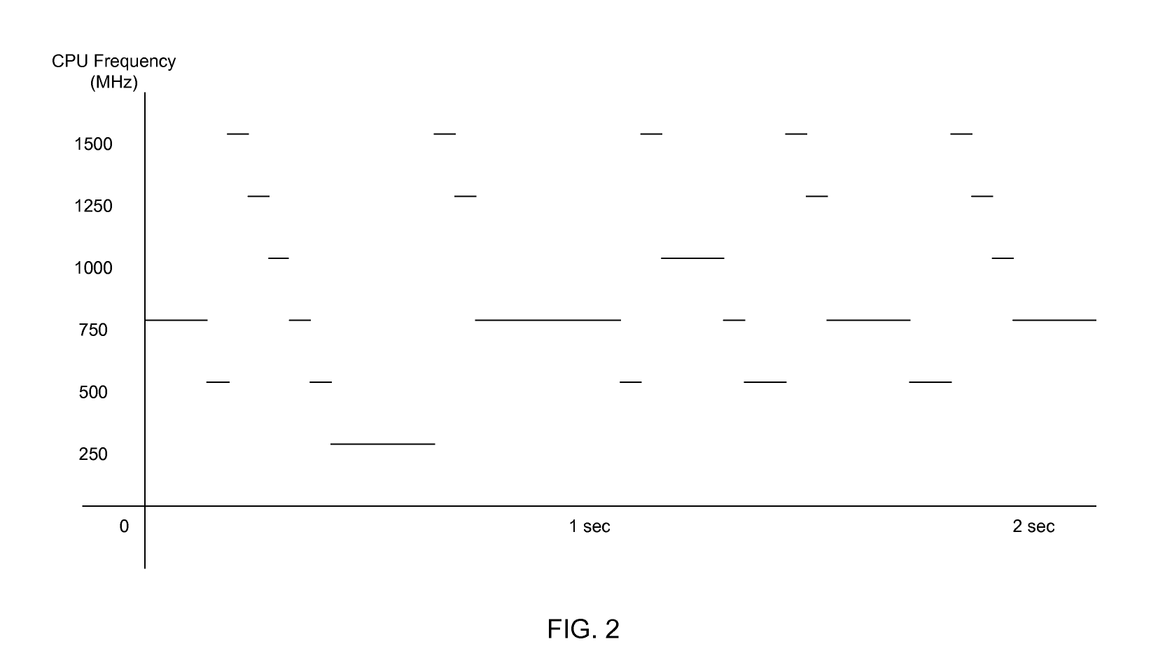

FIG. 3 is an embodiment of a method of operating an enhanced OnDemand Governor;

FIG. 4 is a CPU frequency versus time chart showing one series of CPU frequency recommendations of the enhanced OnDemand Governor;

FIG. 5 is a CPU frequency versus time chart showing another series of CPU frequency recommendations of the enhanced OnDemand Governor;

FIG. 6 is a CPU frequency versus time chart showing yet another series of CPU frequency recommendations of the enhanced OnDemand Governor; and

FIG. 7 is a diagrammatic representation of one embodiment of a computer system within which a set of instructions can execute for causing a device to perform or execute any one or more of the aspects and/or methodologies of the present disclosure.

### DETAILED DESCRIPTION

This disclosure overcomes the problems seen with the OnDemand Governor by looking at long term trends in CPU frequency settings and adjusting the CPU frequency based on these trends rather than just instantaneous threshold comparisons. Trends are monitored via storing CPU frequencies to a history data store and then optionally filtering the data store. A steady-state frequency, as compared to the turbo frequency or a computed lower frequency can then be calculated by filtering the history data store or based on a filtered set of the history data store. The steady-state frequency (or SSF) represents a frequency predicted to more closely match CPU load than the turbo frequency when increased load occurs, and to more quickly match the CPU load than the gradual process of stepping down through computed lower frequencies when a decreased load occurs.

Additionally, one would expect the instant method to trade some performance for increased power savings. In fact, the inventors have discovered greater performance from the instant method (e.g., greater frame rates in gameplay and lower average deviation in frame rates), and these unexpected results suggest that the instant method can improve both performance and power savings (e.g., 8-10% power reduction).

The term “periodic load” is used herein to mean a load that is substantially unchanging such as seen during multimedia playback and video game operation.

The term “CPU frequency” is used herein to mean an operating frequency of the CPU.

The term “OnDemand Governor” is used herein to mean a kernel-based governor that controls a frequency of the CPU or other processor.

The term “OnDemand Logic” is used herein to mean logic circuits and methods that the OnDemand Governor uses to determine how to set the CPU frequency.

The term “CPU Load” is used herein to mean a value representing CPU usage as computed by logic in the OnDemand Governor.

The term “Up_Threshold” is used herein to mean an upper threshold that is used to determine when to increase processor frequency.

The term “Dowd_Threshold” is used herein to mean a lower threshold that is used to determine when to decrease processor frequency.

The term “Turbo Frequency” is used herein to indicate a maximum frequency of the CPU.

The term “Up Request” is used herein to mean a code path taken when the OnDemand Logic decides to increase CPU frequency.

The term “steady-state frequency” of (SSF) is used herein to mean a computed frequency predicted to be an optimal tradeoff between performance and power savings.

The word “exemplary” is used herein to mean “serving as an example, instance, or illustration.” Any embodiment described herein as “exemplary” is not necessarily to be construed as preferred or advantageous over other embodiments.

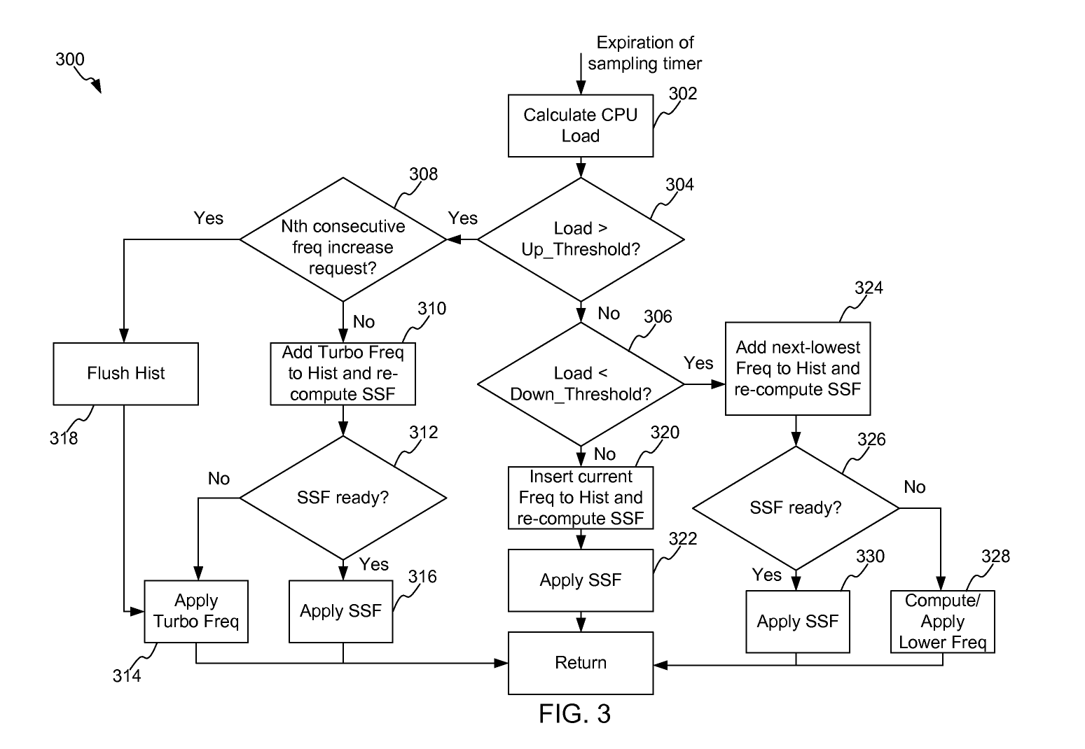

FIG. 3 illustrates a method for controlling CPU frequency via an enhanced version of the OnDemand Governor. The building blocks of the method 300 can be seen from the method 100 and the traditional operation of the OnDemand Governor, including decisions 104, and 108, and blocks 102, 106, 110, and 112. These decisions and operational blocks are similarly embodied in decisions 304, 306 and operational Blocks 302, 214, 322 328, respectively.

The method 300 performs once per sampling cycle (e.g., 50 ms) or once per expiration of a sampling timer. During each loop, the method 300 calculates a load on the CPU (Block 302) and then compares the CPU load to an upper and lower threshold, referred to as Up_Threshold and Down_Threshold, respectively (Decisions 304 and 306, respectively). This comparison can results in three outcomes: the CPU load can be greater than the Up_Threshold, between the Up_Threshold and the Down_Threshold, or less than the Down_Threshold.

If the CPU load is greater than the Up_Threshold (Decision 304), then the method 300 looks at a number of prior consecutive determinations that the load was greater than the Up_Threshold (or cycles in which the CPU frequency has been increased) and compares this number to a threshold value N (decision 308). Where the previous cycle did not call for an increase in CPU frequency, or only a small number of previous cycles (e.g., less than N) have called for increased CPU frequency, the method 300 adds the turbo frequency to a history (e.g., Hist) data store and computes or re-computes a “steady-state frequency” (Block 310). The steady-state frequency can be computed where the method 300 sees its first cycle or where the history data store has been flushed on the previous cycle. The steady-state frequency can be re-computed in all other cases (i.e., where the history data store includes at least one previous CPU frequency value or previous frequency recommended by the OnDemand Governor). In order to have a usable steady-state frequency, the steady-state frequency may have to be computed from two or more CPU frequency values. In such embodiments, the steady-state frequency may not be ready until it is computed from a threshold number, M, of CPU frequency values in the history data store. Hence, a decision 312 can determine if the steady-state frequency is ready (e.g., if there are sufficient (e.g., M) CPU frequency values in the history data store). If the steady-state frequency is not ready for use, (e.g., there are not sufficient CPU frequency values in the history data store), then the method 300 instructs the CPU to set its frequency to the turbo frequency (Block 314). If the steady-state frequency is ready (e.g., M or more values), then the method 300 instructs the CPU to set its frequency to the steady-state frequency (Block 316). Whether the method 300 instructs the CPU to set its frequency to the turbo frequency or to the steady-state frequency, the method 300 then returns to the beginning and waits for an expiration of the sampling timer.

Returning to decision 308, where the method 300 has been trying to raise the CPU frequency in a gradual manner, bur repeated increases have failed (i.e., when the number of consecutive increased frequency requests equals N), the method 300 flushes the history data store (Block 318) and instructs the CPU to set its frequency to the turbo frequency (Block 314) or a highest available CPU frequency. The method 300 then returns to the beginning and waits for an expiration of the sampling timer.

Via the above, the method 300 can gradually increase the CPU frequency in a manner tailored to a longer term trend of previous CPU loads. However, if the load jumps more rapidly than can be handled by this gradual frequency step up, the method 300 can jump to the turbo frequency and flush the history data store in order to begin trend monitoring with a fresh start. This enables the method 300 to generate a steady-state frequency that can be tailored to both small increases in CPU load and also short or longer temporary periods of high CPU load, but with a greater tailoring to the load than merely applying the turbo frequency in all increased load scenarios. As such, the method 300 conserves power compared to the traditional method of operating the OnDemand Governor, while maintaining most of the performance benefits of the ability to quickly jump to the turbo frequency.

At the same time, the method 300 provides benefits during periods where loads are largely unchanged. In particular, if the CPU load is less than the Up_Threshold (or an upper threshold) but greater than the Down_Threshold (or a lower threshold), (Decisions 304 and 306), then the method 300 adds a current frequency (e.g., a frequency that the CPU was instructed to operate at on a previous cycle of the method 300) to the history data store and computes or re-computes a steady-state frequency (Block 320). Again, the steady-state frequency can be computed where the method 300 is seeing its first cycle or where the history data store was flushed on the previous cycle. The method 300 can then instruct the CPU to sets its frequency to the steady-state frequency (Block 322), and loops back to the beginning to await the next cycle. Alternatively, the steady-state frequency may only be computed once there are at least a threshold number of values, (e.g., M or more), in the history data store. In other words, the steady-state frequency may be computed once a sufficient number of loops of the method 300 after a flushing of the history data store, or since a first loop of the method 300, have occurred.

Here it can be seen that where the traditional operation of the OnDemand Governor instructs the CPU to set its frequency to a current frequency (a previous cycle's frequency), the method 300 provides a more tailored response by updating a steady-state frequency and instructing the CPU based on the steady-state frequency rather than the current frequency.

The method 300 also provides a more tailored response when the load is decreasing (e.g., a faster response to dropping CPU loads). If the CPU load is less than the Down_Threshold (decision 306), then the method 300 computes a computed lower frequency and adds this frequency to the history data store and computes or re-computes a steady-state frequency (Block 324) based on the updated history data store. Again, the steady-state frequency can be computed where the method 300 is seeing its first cycle or where the history data store was flushed on the previous cycle. In order to have a usable steady-state frequency, the steady-state frequency may have to be computed from two or more CPU frequency values. In such embodiments, the steady-state frequency may not be ready until it is computed from a threshold number of CPU frequency values in the history data store. Hence, a decision 326 can determine if the steady-state frequency is ready (e.g., if there are sufficient CPU frequency values in the history data store). If the steady-state frequency is not ready for use, (e.g., there are not sufficient CPU frequency values in the history data store), then the method 300 instructs the CPU to set its frequency to a computed lower frequency (Block 328). If the steady-state frequency is ready, then the method 300 instructs the CPU to set its frequency to the steady-state frequency (Block 330). Whether the method 300 instructs the CPU to set its frequency to the turbo frequency or to the steady-state frequency, the method 300 then returns to the beginning and waits for an expiration of the sampling timer.

The following examples show the method 300 in operation.

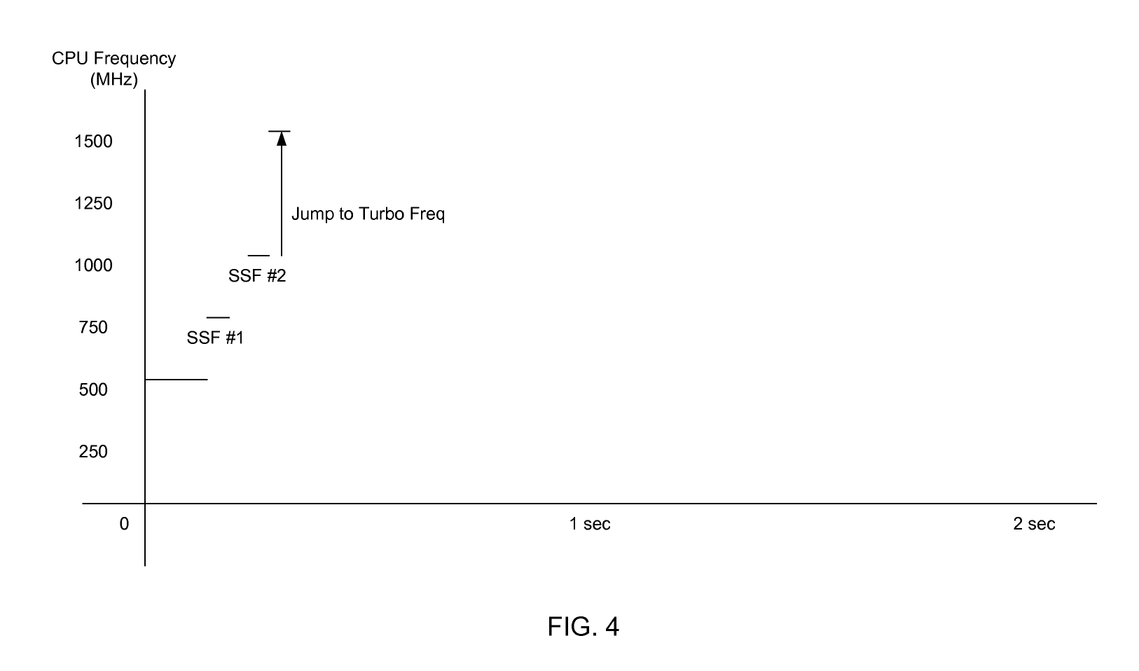

FIG. 4 illustrates a handful of cycles of the method 300, starting with a consistent steady-state frequency of 500 MHz and Block 308 using N=3. An increase in the CPU load leads to two consecutive loops of stepped up steady-state frequencies, (Blocks 302, 304, 308, 310, 312, 316) until Block 308 determines that a third consecutive request for an increased frequency is occurring, and the method 300 instructs the CPU to jump to the turbo frequency (Block 314).

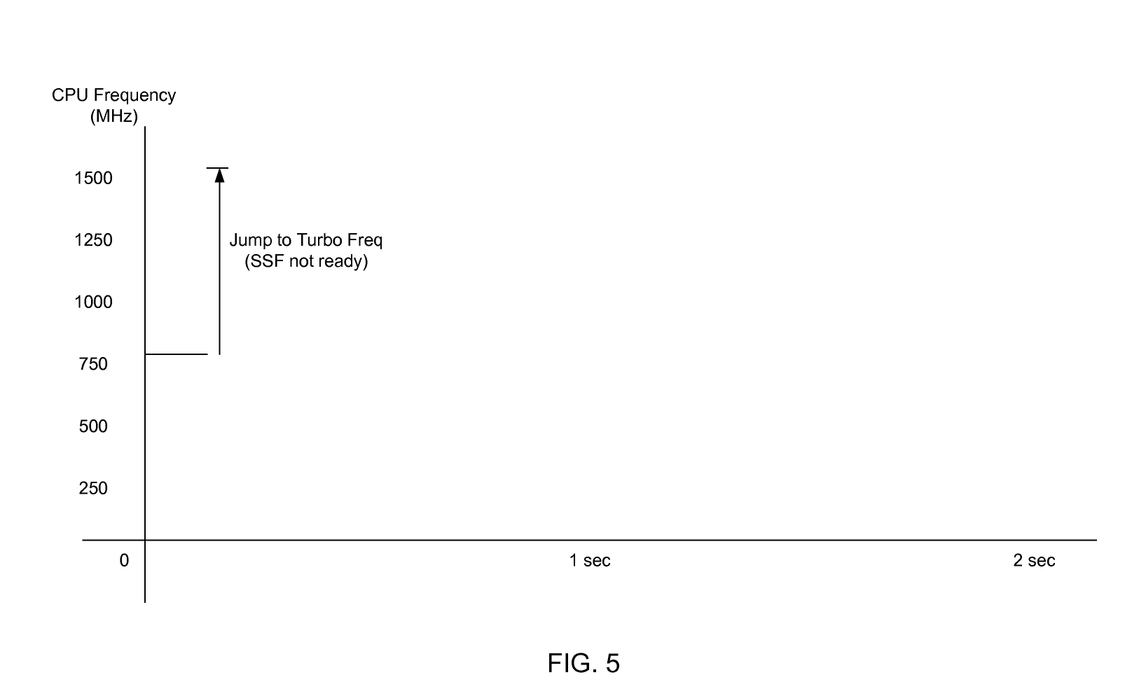

FIG. 5 illustrates a handful of cycles of the method 300, starting with a consistent steady-state frequency of 750 MHz. The method 300 may then determine that the load is greater than the Up_Threshold (decision 304) and attempt to apply an updated steady-state frequency. However, finding that the steady-state frequency is not ready (decision 312), the method 300 may instruct the CPU to set its frequency to the turbo frequency instead (Block 314). This can result in a jump from a consistent steady-state frequency to the turbo frequency as seen in FIG. 5.

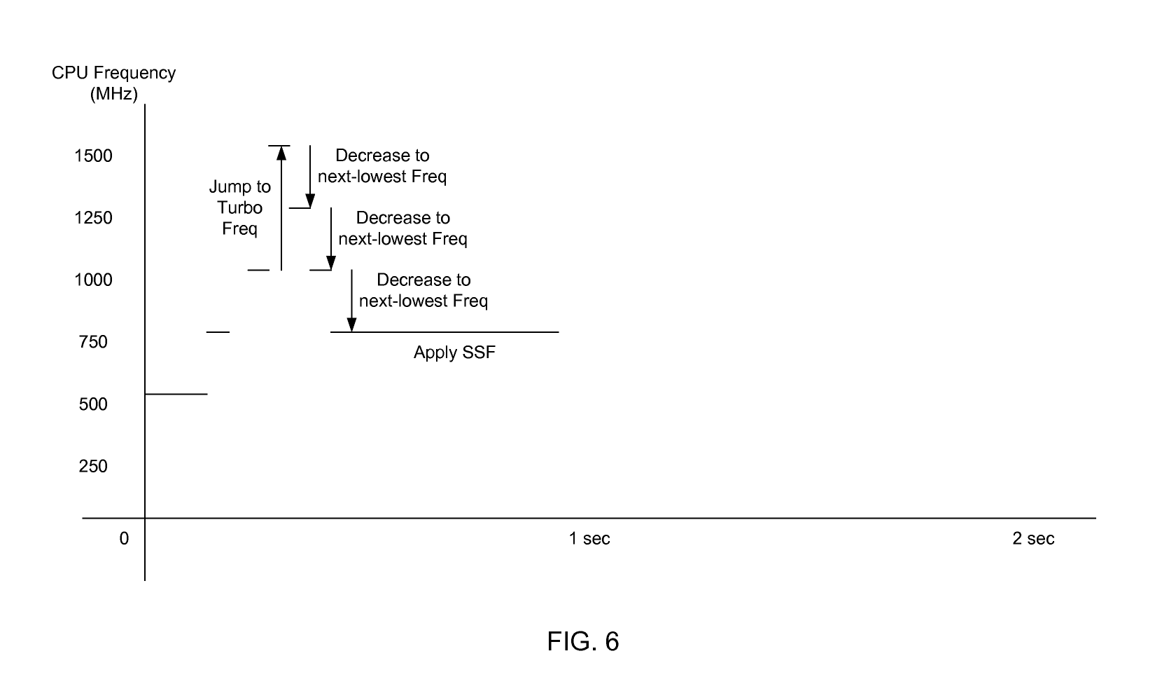

FIG. 6 illustrates a handful of cycles of the method 300, starting with a consistent steady-state frequency of 500 MHz. The method 300 may then step up the steady-state frequency for two cycles and jump to the turbo frequency, as described in FIG. 4. With the jump to the turbo frequency, also comes a flushing of the history data store (Block 318). Thus, after the turbo frequency is applied, the steady-state frequency will not be ready for a few cycles, since the method 300 must rebuild the history data store so that there are sufficient prior CPU frequency values to make a calculation of the steady-state frequency valid. In the illustrated example, the number of CPU frequency values required is 3, and so the method steps down the frequency to a computed lower frequency (Block 328) three times before the steady-state frequency is ready (decision 326). On the fourth cycle after the jump to the turbo frequency, the steady-state frequency is ready and can be applied. In the illustrated embodiment, the steady-state frequency also happens to be the same frequency as the CPU frequency that the previous cycle applied and so no change in frequency is seen between these two cycles.

Blocks 310, 320, and 324 each involve computing or re-computing the steady-state frequency. As noted previously, this computation is based on prior CPU frequency values stored in a history data store. The computation can be performed on all values in the history data store or a subset thereof. For instance, different parameters or user inputs to the Governor may result in the steady-state frequency being computed based on a specified window or number of prior CPU frequency values. In some cases this may involve computing the steady-state frequency from a subset of all values in the history data store, while in other instances it may involve removing values from the history data store so that the number of values in the history data store meets the parameter or user input. Other embodiments may also call for the history data store to have one or more limits to the number of prior CPU frequency values that it can hold, and to meet this requirement, the history data store can remove oldest, or first in, values in order to free space for further CPU frequency values.

The variable N can be set to any value (although 1 or 2 are two preferred values) and can be user-modified based on a desired balance between performance and power savings. The variable M can be set to any value (although 1 or 2 are two preferred values) and can be user-modified based on a desired balance between performance and power savings.

In one embodiment, calculating the load on the CPU (Block 302) can involve summing or averaging the CPU load over a window of time (e.g., a load sampling period). In another embodiment it can involve integrating instantaneous loads on the CPU over a window of time.

The Up_Threshold and the Down_Threshold can be taken relative to a variety of measurements. For instance, they can be compared to a percentage of a window of time during which the CPU was in use or to a percentage of a window of time during which the CPU was operating at least X % of capacity. For instance, the Up_Threshold can be 95%, or 90%, or 85%, or 80%, or 75% or 70%, to name a few non-limiting examples.

The enhanced OnDemand Governor described herein can be implemented as a module within a LINUX Kernel of a computing device's operating system. Hence, the methods herein described can be carried out by a LINUX Kernel. The herein disclosed methods can also be applied within the OnDemandX Governor.

In order to provide a steady-state frequency that is less influenced by outliers, computations and re-computations of steady-state frequency can begin by filtering a subset of, or all, values in the history data store. Filters can include averages and weighted averages, to name two non-limiting examples. The steady-state frequency may also be calculated based on a moving average or moving weighted average, such that the steady-state frequency is only calculated from a fixed number of the most recent values in the history data store (e.g., CPU frequencies applied in the past 2 seconds or in the past 40 cycles, to name two non-limiting examples).

Decisions 312 and 326 determine whether the steady-state frequency is ready. In other words, these decisions 312, 326 determine if sufficient prior CPU frequency values are available in the history data store to calculate a reliable steady-state frequency. For instance, calculating steady-state frequency when only one or two values are in the history data store is more likely to result in a steady-state frequency highly influenced by an outlier, than if a greater number of prior CPU frequency values are used. Thus, until some baseline number of prior CPU frequency values are available, the steady-state frequency is not used. The number of prior CPU frequency values required for the steady-state frequency to be ready can vary and is no way limited to the examples discussed herein.

Blocks 324 and 328 both involve a computed lower frequency. The computed lower frequency can be determined in a variety of ways. For instance, where the CPU includes a frequency table, the Block 324 can start by computing a minimum frequency required for the CPU to process the current load given a certain time window. The Block 324 then compares the computed minimum frequency with the frequency table for the CPU and finds either the minimum frequency or a frequency slightly higher than the minimum frequency (i.e., an available CPU frequency that is equal to or greater than the minimum frequency required to handle the existing load). This frequency is identified as the computed lower frequency and added to the history data store in Block 324 and possibly later used in Block 328 when instructing the CPU to set its frequency.

The inventors also recognize that this enhanced OnDemand Governor method is more useful for periodic loads than dynamic ones. As such, when a user switches from a video to a game or from a game to e-mail, the traditional OnDemand Governor method may actually be preferred. As such, in an embodiment, the OnDemand Governor may default to its traditional method and only implement the instant enhanced method when a user device has settled into a use case identified as appropriate for the instant enhanced method (e.g., a periodic load). For example, middleware or drivers can detect a start of audio, video, or gaming and provide a signal that allows the enhanced OnDemand Governor method to take over. On the other hand, the enhanced method may wait until a certain time period has passed or some other indication is given that the user device has settled into a periodic load regime. Similarly, the middleware or drivers can detect an end to such a session of a periodic load and enable the OnDemand Governor to switch back to a traditional method of operation. In the case of ANDROID, Powerhaul can be used to determine when the OnDemand Governor should be operated in a traditional or the herein disclosed enhanced mode.

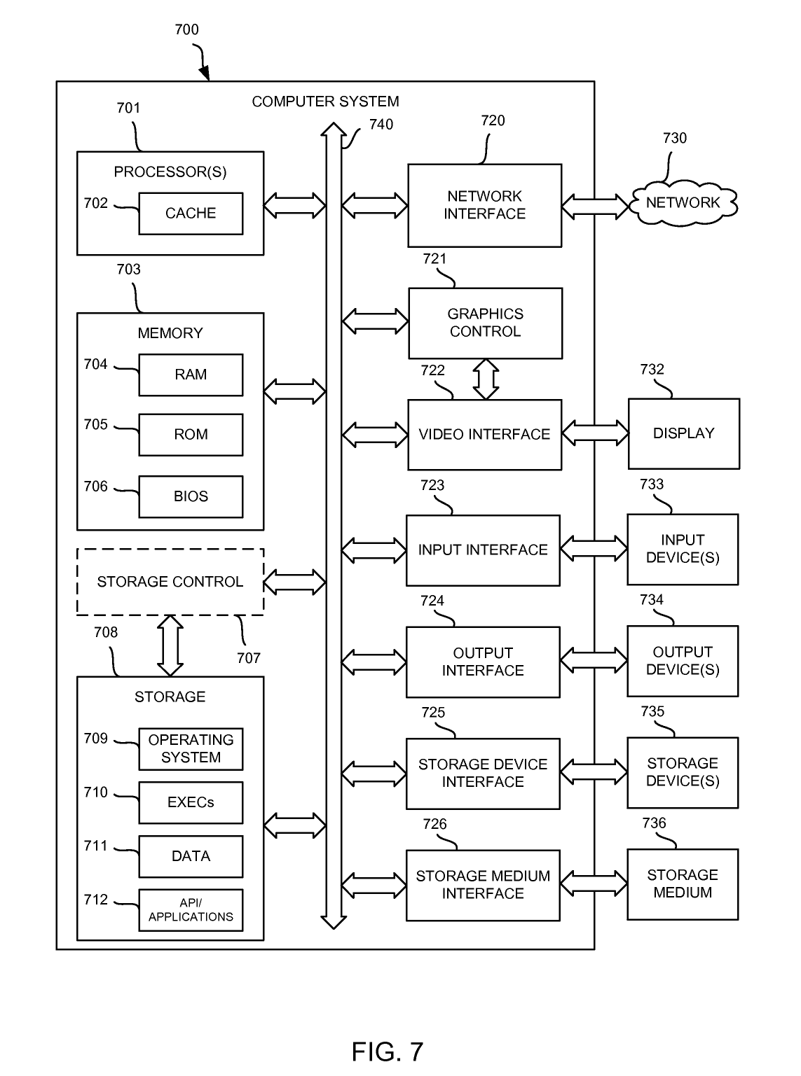

The systems and methods described herein can be implemented in a computer system in addition to the specific physical devices described herein. FIG. 7 shows a diagrammatic representation of one embodiment of a computer system 700 within which a set of instructions can execute for causing a device to perform or execute any one or more of the aspects and/or methodologies of the present disclosure. An ANDROID smartphone running the LINUX Kernel is one implementation of the computer system 700. The components in FIG. 7 are examples only and do not limit the scope of use or functionality of any hardware, software, firmware, embedded logic component, or a combination of two or more such components implementing particular embodiments of this disclosure. Some or all of the illustrated components can be part of the computer system 700. For instance, the computer system 700 can be a general purpose computer (e.g., a laptop computer) or an embedded logic device (e.g., an FPGA), to name just two non-limiting examples.

Computer system 700 includes at least a processor 701 such as a central processing unit (CPU) or an FPGA to name two non-limiting examples. One or more of the processors in a smartphone exemplify one implementation of the processor 701. The computer system 700 may also comprise a memory 703 and a storage 708, both communicating with each other, and with other components, via a bus 740. The bus 740 may also link a display 732, one or more input devices 733 (which may, for example, include a keypad, a keyboard, a mouse, a stylus, etc.), one or more output devices 734, one or more storage devices 735, and various non-transitory, tangible computer-readable storage media 736 with each other and with one or more of the processor 701, the memory 703, and the storage 708. All of these elements may interface directly or via one or more interfaces or adaptors to the bus 740. For instance, the various non-transitory, tangible computer-readable storage media 736 can interface with the bus 740 via storage medium interface 726. Computer system 700 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 701 (or central processing unit(s) (CPU(s))) optionally contains a cache memory unit 702 for temporary local storage of instructions, data, or computer addresses. Processor(s) 701 are configured to assist in execution of computer-readable instructions stored on at least one non-transitory, tangible computer-readable storage medium. Computer system 700 may provide functionality as a result of the processor(s) 701 executing software embodied in one or more non-transitory, tangible computer-readable storage media, such as memory 703, storage 708, storage devices 735, and/or storage medium 736 (e.g., read only memory (ROM)). For instance, the method 300 in FIG. 3 may be embodied in one or more non-transitory, tangible computer-readable storage media. The non-transitory, tangible computer-readable storage media may store software that implements particular embodiments, such as the 300, and processor(s) 701 may execute the software. Memory 703 may read the software from one or more other non-transitory, tangible computer-readable storage media (such as mass storage device(s) 735, 736) or from one or more other sources through a suitable interface, such as network interface 720. A network interface on a smartphone is one embodiment of the network interface 720. The software may cause processor(s) 701 to carry out one or more processes or one or more steps of one or more processes described or illustrated herein. Carrying out such processes or steps may include defining data structures stored in memory 703 and modifying the data structures as directed by the software. In some embodiments, an FPGA can store instructions for carrying out functionality as described in this disclosure (e.g., the method 300). In other embodiments, firmware includes instructions for carrying out functionality as described in this disclosure (e.g., the method 300).

The memory 703 may include various components (e.g., non-transitory, tangible computer-readable storage media) including, but not limited to, a random access memory component (e.g., RAM 704) (e.g., a static RAM “SRAM”, a dynamic RAM “DRAM, etc.), a read-only component (e.g., ROM 705), and any combinations thereof. ROM 705 may act to communicate data and instructions unidirectionally to processor(s) 701, and RAM 704 may act to communicate data and instructions bidirectionally with processor(s) 701. ROM 705 and RAM 704 may include any suitable non-transitory, tangible computer-readable storage media described below. In some instances, ROM 705 and RAM 704 include non-transitory, tangible computer-readable storage media for carrying out the method 300. In one example, a basic input/output system 706 (BIOS), including basic routines that help to transfer information between elements within computer system 700, such as during start-up, may be stored in the memory 703.

Fixed storage 708 is connected bidirectionally to processor(s) 701, optionally through storage control unit 707. Fixed storage 708 provides additional data storage capacity and may also include any suitable non-transitory, tangible computer-readable media described herein. Storage 708 may be used to store operating system 709, EXECs 710 (executables), data 711, API applications 712 (application programs), and the like. For instance, the storage 708 could be implemented for storage of the history data store and/or the Up_Threshold and the Down_Threshold as described in FIG. 3. Often, although not always, storage 708 is a secondary storage medium (such as a hard disk) that is slower than primary storage (e.g., memory 703). Storage 708 can also include an optical disk drive, a solid-state memory device (e.g., flash-based systems), or a combination of any of the above. Information in storage 708 may, in appropriate cases, be incorporated as virtual memory in memory 703.

In one example, storage device(s) 735 may be removably interfaced with computer system 700 (e.g., via an external port connector (not shown)) via a storage device interface 725. Particularly, storage device(s) 735 and an associated machine-readable medium may provide nonvolatile and/or volatile storage of machine-readable instructions, data structures, program modules, and/or other data for the computer system 700. In one example, software may reside, completely or partially, within a machine-readable medium on storage device(s) 735. In another example, software may reside, completely or partially, within processor(s) 701.

Bus 740 connects a wide variety of subsystems. Herein, reference to a bus may encompass one or more digital signal lines serving a common function, where appropriate. Bus 740 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 700 may also include an input device 733. In one example, a user of computer system 700 may enter commands and/or other information into computer system 700 via input device(s) 733. Examples of an input device(s) 733 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 733 may be interfaced to bus 740 via any of a variety of input interfaces 723 (e.g., input interface 723) including, but not limited to, serial, parallel, game port, USB, FIREWIRE, THUNDERBOLT, or any combination of the above.

In particular embodiments, when computer system 700 is connected to network 730 (such the Internet or a cellular network), computer system 700 may communicate with other devices, such as mobile devices and enterprise systems, connected to network 730. Communications to and from computer system 700 may be sent through network interface 720. For example, network interface 720 may receive incoming communications (such as requests or responses from other devices) in the form of one or more packets (such as Internet Protocol (IP) packets) from network 730, and computer system 700 may store the incoming communications in memory 703 for processing. Computer system 700 may similarly store outgoing communications (such as requests or responses to other devices) in the form of one or more packets in memory 703 and communicated to network 730 from network interface 720. Processor(s) 701 may access these communication packets stored in memory 703 for processing.

Examples of the network interface 720 include, but are not limited to, a network interface card, a modem, and any combination thereof. Examples of a network 730 or network segment 730 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 730, may employ a wired and/or a wireless mode of communication. In general, any network topology may be used.

Information and data can be displayed through a display 732. Examples of a display 732 include, but are not limited to, a liquid crystal display (LCD), an organic liquid crystal display (OLED), a cathode ray tube (CRT), a plasma display, and any combinations thereof. The display 732 can interface to the processor(s) 701, memory 703, and fixed storage 708, as well as other devices, such as input device(s) 733, via the bus 740. The display 732 is linked to the bus 740 via a video interface 722, and transport of data between the display 732 and the bus 740 can be controlled via the graphics control 721.

In addition to a display 732, computer system 700 may include one or more other peripheral output devices 734 including, but not limited to, an audio speaker, a printer, and any combinations thereof. Such peripheral output devices may be connected to the bus 740 via an output interface 724. Examples of an output interface 724 include, but are not limited to, a serial port, a parallel connection, a USB port, a FIREWIRE port, a THUNDERBOLT port, and any combinations thereof.

In addition or as an alternative, computer system 700 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Within this specification, the same reference characters are used to refer to terminals, signal lines, wires, etc. and their corresponding signals. In this regard, the terms “signal,” “wire,” “connection,” “terminal,” and “pin” may be used interchangeably, from time-to-time, within the this specification. It also should be appreciated that the terms “signal,” “wire,” or the like can represent one or more signals, e.g., the conveyance of a single bit through a single wire or the conveyance of multiple parallel bits through multiple parallel wires. Further, each wire or signal may represent bi-directional communication between two, or more, components connected by a signal or wire as the case may be.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, or microcontroller. A processor may also be implemented as a combination of computing devices, e.g., a combination of a DSP and a microprocessor, a plurality of microprocessors, one or more microprocessors in conjunction with a DSP core, or any other such configuration. The steps of a method or algorithm described in connection with the embodiments disclosed herein (e.g., the method 300) may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor such that the processor can read information from, and write information to, the non-transitory, tangible computer-readable storage medium. In the alternative, the non-transitory, tangible computer-readable storage medium may be integral to the processor. The processor and the non-transitory, tangible computer-readable storage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system comprising:
a CPU operating at two or more available frequencies;
a history data store configured to store the two or more available frequencies;
a CPU frequency governor comprising a non-transitory, tangible computer readable storage medium, encoded with processor readable instructions to perform a method for controlling a frequency of the CPU, the method comprising:
monitoring a load on the CPU;
determining that the CPU load exceeds an upper threshold;
adding a turbo frequency to the history data store;
calculating a steady-state frequency based on a filtered set of frequencies in the history data store; and
instructing the CPU to set its frequency to the steady-state frequency.

2. The system of claim 1, further comprising instructing the CPU to set its frequency to the turbo frequency if there are insufficient CPU frequency data values in the history data store.

3. The system of claim 1, further comprising instructing the CPU to set its frequency to the turbo frequency if the CPU frequency governor determines that the CPU load exceeds the upper threshold and that the CPU load exceeded the upper threshold on a last cycle of the CPU frequency governor.

4. The system of claim 1, further comprising instructing the CPU to set its frequency to the turbo frequency if the CPU frequency governor determines that the CPU load exceeds the upper threshold and that the CPU load exceeded the upper threshold on a last two consecutive cycles of the CPU frequency governor.

5. A method of operating a CPU frequency governor to optimize performance and power savings for periodic CPU loads, the method comprising:
(1) calculating a load on a CPU by integrating instantaneous loads on the CPU over a load sampling period; and
(2) if the load is greater than an upper threshold, then:
if there have been N prior consecutive determinations that the load was greater than the upper threshold, flush a history data store and instruct the CPU to set its frequency to a turbo frequency, and if not, then:
add the turbo frequency to the history data store;
compute a steady-state frequency from the history data store; and
if the steady-state frequency has been computed from M or more data points in the history data store, set the CPU frequency to the steady-state frequency, and if not, set the CPU frequency to the turbo frequency.

6. The method of claim 5, wherein if the load is between the upper threshold and a lower threshold, then:
add a current CPU frequency to the history data store;
compute the steady-state frequency from the history data store; and
set the CPU frequency to the steady-state frequency.

7. The method of claim 6, wherein if the load is less than the lower threshold, then:
add a computed lower frequency to the history data store;
compute the steady-state frequency based on the history data store; and
if the steady-state frequency has been computed from M or more data points in the history data store, set the CPU frequency to the steady-state frequency, and if not, set the CPU frequency to the computed lower frequency.

8. The method of claim 5, wherein the method is applied only where a periodic CPU load is detected or only application or processes associated with periodic CPU loads are running.

9. The method of claim 8, wherein if a source of the load is either unknown or is known to place non-periodic loads on the CPU, than a traditional method of operating a CPU frequency governor is carried out.

10. The method of claim 9, wherein the CPU frequency governor is the OnDemand Governor.

11. The method of claim 5, wherein a filter is applied to the history data store in order to compute the steady-state frequency.

12. The method of claim 11, wherein the filter is an average.

13. The method of claim 5, wherein when a frequency data point is added to the history data store, an oldest frequency data point is removed from the history data store.

14. A non-transitory, tangible computer readable storage medium, encoded with processor readable instructions to perform a method for controlling a CPU frequency governor, the method comprising:
monitoring a CPU load;
determining that the CPU load exceeds an upper threshold;
determining that N prior consecutive increases to the CPU frequency have been attempted; and
instructing the CPU to set its frequency to a turbo frequency.

15. The non-transitory, tangible computer readable storage medium of claim 14, further comprising:
on a subsequent cycle,
monitoring the CPU load;
determining that the CPU load exceeds the upper threshold;
determining that less than N prior consecutive increases to the CPU frequency have been attempted; and
instructing the CPU to set its frequency to the steady-state frequency as computed from a history data store containing prior CPU frequency values.

16. The non-transitory, tangible computer readable storage medium of claim 14, further comprising:
on a subsequent cycle,
monitoring the CPU load;
determining that the CPU load is below a lower threshold; and
instructing the CPU to set its frequency to the steady-state frequency as computed from a history data store containing prior CPU frequency values.

17. The non-transitory, tangible computer readable storage medium of claim 14, further comprising:
on a subsequent cycle,
monitoring the CPU load;
determining that the CPU load is between the upper threshold and the lower threshold; and
instructing the CPU to set its frequency to the steady-state frequency as computed from a history data store containing prior CPU frequency values.

18. The non-transitory, tangible computer readable storage medium of claim 14, further comprising flushing the history data store when it is determined that that N prior consecutive increases to the CPU frequency have been attempted.

19. The non-transitory, tangible computer readable storage medium of claim 14, further comprising:
on a subsequent cycle,
adding the turbo frequency to the history data store;
computing a steady-state frequency based on at least a subset of the history data store; and
instructing the CPU to set its frequency to the steady-state frequency.
